(19) United States
(12) Patent Application Publication
(10) Pub. No.: US 2011/0192292 A1
(43) Pub. Date: Aug. 11, 2011

(54) MACHINE AND METHOD FOR COMPACTING AN ANNULAR PART MADE OF A FLEXIBLE MATERIAL

(76) Inventor: Didier André Louis Marrel, Vaugneray (FR)

(21) Appl. No.: 13/055,648

(22) PCT Filed: Jul. 22, 2009
(86) PCT No.: PCT/FR2009/051473

§ 371 Date: Apr. 5, 2011

(30) Foreign Application Priority Data
Jul. 22, 2008 (FR) FR-08 04156

(51) Int. Cl. B30B 1/00

(52) U.S. Cl. 100/35; 100/214

(57) ABSTRACT

The invention relates to a machine (1) for compacting an annular part (2) made of a flexible material, said machine (1) having a section-reducing passage (4) through which the annular part (2) is forced in order to be folded, said machine (1) being characterized in that said section-reducing passage (4) is defined by at least one section-reducing plate (5) that is pivotally mounted so that, under thrust from said annular part (2), said section-reducing plate (5) pivots so as to come to close onto said annular part (2) in order to compress it.

### TECHNICAL FIELD

The present invention relates to the general technical field of waste treatment methods, and in particular methods aimed at making waste more compact with a view to storing it and to subsequently treating it.

The present invention relates more particularly to a machine for compacting an annular part made of a flexible material, said machine having a section-reducing passage through which the annular part is forced in order to be folded.

The present invention also relates to a method of compacting an annular part made of a flexible material, in which method the annular part is forced through a section-reducing passage in order to be folded.

The invention finally relates to a system comprising a pneumatic tire that is folded in such a manner as to form two lobes interconnected by a section constriction resulting from the tire being subjected to local centripetal compression, said lobes being folded over one against the other.

### PRIOR ART

Due to its shape, an annular part occupies a volume that is large compared with the volume of material that it actually represents. If annular parts are stacked for storing them or transporting them, their annular shape leaves the entire central portion of the stack empty. In addition to being voluminous, they are, depending on their size, difficult to handle simply.

This voluminous nature of annular parts raises considerable problems, in particular for treating used tires.

It is therefore extremely judicious (particularly from an economic point of view) to compact used tires prior to storing them and to transporting them subsequently.

To this end, it is known from Document FR 2 631 563 A1 that used tires can be folded along two perpendicular diameters in a plane orthogonal to the axis of the tire, the tire folded in that way then being tied so as to be held in its folded shape.

The method described in Document FR 2 631 563 thus makes it possible to reduce the overall volume of the tire significantly.

Unfortunately it suffers from certain drawbacks.

Firstly, that known method requires the tire to be subjected to cutting operations prior to it being subjected to folding proper. Those cutting operations require implementation of special tooling (involving investment and maintenance) and are time-consuming and resource-consuming, which is not conducive to optimizing the cost of the method.

In addition, those cutting operations generate at least four tire off-cuts per tire, those off-cuts constituting so many additional pieces of waste to be treated, which, naturally, is not conducive to reducing the complexity and the costs of treatment either.

Document FR 2 631 563 A1 also makes provision, once the tire has been cut at least four places, for the tire to be subjected to a folding operation in which said tire is folded along two perpendicular diameters in a plane orthogonal to the axis of the tire, by forcing the tire between two plates. More precisely, the tire is forced between the plates by an actuator that acts radially on the tire, in register with any one of the four nicks (or cuts) previously made in the tire. The four nicks in question thus act as folding hinges making it possible to fold the tire into the desired profile. In order to facilitate the folding operation, the plates form a flared inlet equipped with two guide wheels, the distance between the axes of which is adjustable. The presence of those mechanical components is naturally conducive to increasing the design complexity of the machine and increases the risk of it failing (e.g. by either of the wheels seizing). Finally, merely forcing the tire between the plates is not necessarily sufficient to obtain sufficiently tight folding. Therefore, one of the plates between which the tire is forced in order to fold it is mounted to move in translation via an actuator that makes it possible to subject the tire to final clamping. That final clamping operation performed by means of an actuator naturally also increases the design complexity of the machine, and consumes cycle time and energy.

### SUMMARY OF THE INVENTION

Objects assigned to the invention are therefore to remedy the various above-mentioned drawbacks of the prior art, and to propose a novel machine and a novel method for compacting an annular part made of a flexible material, of the pneumatic tire type, that are particularly simple, reliable, and inexpensive, that can treat annular parts of all sizes, and that can do so without requiring any prior shearing of said annular parts.

Another object of the invention is to propose a novel machine and a novel method for compacting an annular part made of a flexible material that make it possible for said annular part to be folded particularly rapidly and effectively.

Another object of the invention is to propose a novel machine and a novel method for compacting an annular part made of a flexible material that implement means that are particularly simple and inexpensive.

Another object of the invention is to propose a novel machine and a novel method for compacting an annular part made of a flexible material that operate rapidly while also limiting untimely mechanical forces that might damage the machine.

Another object of the invention is to propose a novel machine and a novel method for compacting an annular part made of a flexible material that are easy to automate and that make it possible to achieve high throughput rates.

Another object of the invention is to propose a novel machine and a novel method for compacting an annular part made of a flexible material that make it possible to reduce the overall volume of said annular part significantly, e.g. by as much as about 70%.

Another object of the invention is to propose a novel system comprising a tire, preferably a used tire, that makes it possible to reduce the overall volume of the tire significantly and to facilitate handling and subsequent treatment thereof.

The objects assigned to the invention are achieved by means of a machine for compacting an annular part made of a flexible material, said machine having a section-reducing passage through which the annular part is forced in order to be folded, said machine being characterized in that said section-reducing passage is defined by at least one section-reducing plate that is pivotally mounted so that, under thrust from said annular part, said section-reducing plate pivots so as to come to close onto said annular part in order to compress it.

The objects assigned to the invention are also achieved by means of a method of compacting an annular part made of a flexible material, in which method the annular part is forced through a section-reducing passage in order to be folded, said method being characterized in that said section-reducing passage is defined by at least one section-reducing plate that is pivotally mounted so that, under thrust from said annular part, said section-reducing plate pivots so as to come to close onto said annular part in order to compress it.

The objects assigned to the invention are also achieved by means of a system comprising a pneumatic tire that is folded in such a manner as to form two lobes interconnected by a section constriction resulting from the tire being subjected to local centripetal compression, said lobes being folded over one against the other, said system being characterized in that said tire is substantially whole.

### BRIEF DESCRIPTION OF THE DRAWINGS

Other features and advantages of the invention appear and stand out in more detail from the following description given with reference to the accompanying drawings which are given merely by way of non-limiting example, and in which:

FIG. 1 is a diagrammatic front view of a compactor machine of the invention;

FIG. 2 is a diagrammatic side view of the machine of FIG. 1;

FIG. 3 shows a step for receiving and for centering the tire that is implemented in the method of the invention, by using the machine of FIGS. 1 and 2;

FIG. 4 shows a pre-compression step of the method of the invention that is performed by using the machine of FIGS. 1 and 2;

FIG. 5 shows a folding step of the method of the invention that is performed by using the machine of FIGS. 1 and 2;

FIG. 6 shows a binding step implemented in the method of the invention that is performed by using the machine of FIGS. 1 and 2; and

FIG. 7 shows a releasing step of the method of the invention that is performed by using the machine of FIGS. 1 and 2 and that makes it possible to obtain a system of the invention.

### BEST MANNER OF IMPLEMENTING THE INVENTION

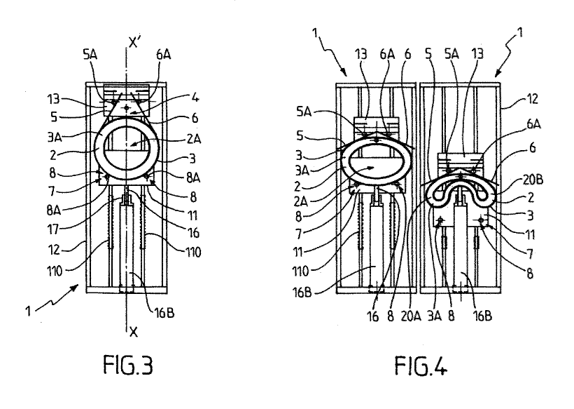

In a first aspect, the invention relates to a machine 1 for compacting an annular part 2 made of a flexible material. The annular part 2 in question thus has a circular shape, and is preferably circularly symmetrical about an axis of symmetry that is perpendicular to the plane of the sheet bearing FIGS. 3 to 7. Preferably, the machine is designed to compact an annular part that is made of a flexible material and that has a circularly symmetrical shape generated by rotating a U-shaped profile about an axis of revolution, the branches of the U extending substantially perpendicularly to said axis of rotation, towards said axis. The term “flexible material” is used herein to designate an elastic and easily deformable material, such as rubber. In the example shown in the figures, the machine 1 thus makes it possible to reduce the section of the annular part 2, i.e. to reduce the empty central section 2A surrounded by the annular part 2, with a view to reducing the overall volume of said part. The machine 1 of the invention may also be referred to as a “section-reducing machine”. The reduction in overall volume that is achieved by the machine 1 makes it possible to facilitate handling, storing, and transporting the annular part 2 that has its overall volume reduced, for example, by approximately in the range 60% to 70% by the machine 1.

Preferably, the machine 1 of the invention constitutes a machine for compacting tires, and more preferably used tires, for the purpose of reducing the storage volume and the transport volume of such tires.

In this preferred use that corresponds to the example shown, the machine 1 is thus specially designed for compacting an annular part 2 constituted by a tire. Such a tire conventionally has a tread strip 3 and two sidewalls 3A extending from the sides of the tread strip. In the description below, for reasons of simplicity and concision, reference is made exclusively to a machine 1 for compacting used tires, it nevertheless being understood that the invention is in no way limited to this preferred use.

In accordance with the invention, the machine 1 has a section-reducing passage 4 through which the annular part 2 is designed to be forced in order to be folded. In other words, the machine 1 has means making it possible to force the annular part 2 through the section-reducing passage 4, the path of the annular part 2 through the section-reducing passage 4 causing the annular part 2 to be deformed. Preferably, as shown in the figures, the section-reducing passage 4 is designed to exert compression action on the annular part 2 as it is forced along its path through the section-reducing passage 4, which compression action is exerted diametrically, i.e. in the midplane of the empty section 2A. In accordance with the invention, the section-reducing passage 4 is defined by at least one section-reducing plate 5 that is pivotally mounted so that, under thrust from the annular part 2 (caused by said part being forced into the section-reducing passage 4), said section-reducing plate 5 pivots so as to come to close onto the annular part 2 in order to compress it. In other words, the section-reducing passage 4 is of variable shape, and more precisely of variable through section, the variation in the shape of the section-reducing passage 4 being caused by the thrust exerted by the annular part 2 on the section-reducing plate 5 while the annular part 2 is being forced into the section-reducing passage 4. The section-reducing plate 5 is thus preferably mounted to be free to pivot, so that it can be caused to move naturally under the effect of the annular part 2 passing into the section-reducing passage 4. By means of this technical characteristic, the section-reducing passage 4 closes progressively and automatically onto the annular part 2 as said part advances into the section-reducing passage 4. This facilitates inserting the annular part 2 into the section-reducing passage 4, without it being necessary to use any special members of the flared-inlet type or of the guide wheel type.

The progressiveness of the compression force exerted by the section-reducing passage 4, by means of the natural pivoting of the section-reducing plate 5, also makes it possible to compress the annular part 2 to a considerable extent, while reducing the risk of applying mechanical forces that might damage the machine 1. In addition, the use of a section-reducing plate 5 that is mounted to be free to pivot makes it possible, automatically, to optimize the positioning of the annular part 2 relative to the section-reducing passage 4, thereby making it possible to limit the risks of the annular part 2 being folded incorrectly due to improper positioning of said annular part.

Implementing a section-reducing passage 4 formed at least in part of a pivotally mounted moving section-reducing plate 5 makes it possible to compact the annular part 2 extremely rapidly, simply, and effectively, in particular making it unnecessary to cut the annular part 2 first. Preferably, the machine 1 does not have any means for cutting for the annular part 2, and, in particular, does not have any means for cutting the annular part 2 before it is forced through the section-reducing passage 4.

Preferably, as shown in the figures, the section-reducing passage 4 is defined by two section-reducing plates 5, 6, each of which is pivotally mounted so that, under thrust from the annular part 2, which thrust is caused by relative movement of the section-reducing passage 4 and of the annular part 2, said section-reducing plate 5, 6 pivot so as to close onto the annular part 2 so as to compress it. Advantageously, and as shown in the figures, the plates 5, 6 are substantially identical and mounted facing each other and symmetrically about a midplane represented by the axis X-X′ in FIG. 1. In the example shown in the figures, the section-reducing plates 5, 6 are advantageously constituted by steel plates. Substantially, the width of each of the steel plates is greater than or equal to the width of the tread strip 3 of the tire forming the annular part 2 for compacting.

Each section-reducing plate 5, 6 is mounted to be free to pivot about a corresponding axis 5A, 6A that preferably extends substantially parallel to the axis of symmetry of the tire, when said tire arrives for being forced through the section-reducing passage 4, as shown in FIG. 3.

Each pivot axis 5A, 6A is preferably positioned equidistantly from an axis X-X′ that coincides with a diameter of the tire, so that the section-reducing plates 5, 6 act simultaneously and symmetrically as the tire advances through the section-reducing passage 4.

Advantageously, the machine 1 of the invention includes reception and centering means 7 for receiving and centering the annular part 2. The reception and centering means 7 are designed to receive and to support the annular part 2 that is to be compacted. Said reception and centering means 7 advantageously include longitudinal centering means 8 on which the annular part 2 comes to rest in a predetermined longitudinal position that it preferably takes up naturally under the effect of its own weight. For this purpose, the longitudinal centering means 8 are designed to interact with the annular part 2 in such a manner as said annular part finds itself in a predetermined position (shown in FIG. 3) centered on the middle axis X-X′ of the section-reducing passage 4. For this purpose, the longitudinal centering means 8 are advantageously designed so that the annular part 2 rests on said longitudinal centering means 8 via its edge face, i.e. via its tread strip 3 when the annular part 2 is constituted by a tire, as shown. For this purpose, the longitudinal centering means 8 advantageously comprise two longitudinal centering tubes 8A that extend substantially parallel to the axis of symmetry of the annular part 2 and to the pivot axes 5A, 6A of the section-reducing plates 5, 6.

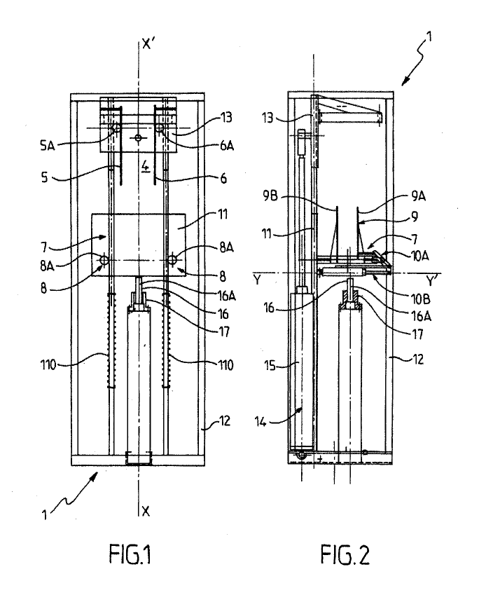

Advantageously, the reception and centering means 7 include lateral centering means 9 (shown in FIG. 2 only) making it possible to position the annular part 2 correctly in the lateral direction (represented by the axis Y-Y in FIG. 2) perpendicular to the longitudinal direction. Preferably, the lateral centering means 9 are provided with at least one moving clamping plate 9A and preferably with two moving clamping plates 9A, 9B that center the annular part 2 laterally. The two clamping plates 9A and 9B are advantageously mounted on runners, and are moved, preferably symmetrically, by a crank-and-connecting rod system 10A that is advantageously actuated by an actuator 10B, as shown in FIG. 2.

Advantageously, the reception and centering means 7 comprise a slidably mounted reception and centering carriage 11. Preferably, the reception and centering carriage 11 slides in the vertical direction represented by the axis X-X′, which direction corresponds to the direction of relative movement of the annular part 2 and of the section-reducing passage 4.

Advantageously, the reception and centering carriage 11 is slidably mounted on a frame 12 to slide between a low abutment position, shown in FIGS. 5 to 7, and a high abutment position, shown in FIGS. 1 to 3. Preferably, the reception and centering carriage 11 is subjected to the action of a return spring 110 (or of two return springs 110, as shown) so as to be continuously urged back into its high abutment position.

Advantageously, the machine 1 also has a slidably mounted pre-compression carriage 13 on which the section-reducing passage 4 is mounted, i.e. the one or more section-reducing plates 5, 6 (depending on the embodiment) are pivotally mounted on the pre-compression carriage 13. Preferably, the pre-compression carriage 13 is slidably mounted on the frame 12. It preferably slides vertically, i.e. in the direction represented by the axis X-X′ in FIG. 1. Thus, the reception and centering carriage 11 and the pre-compression carriage 13 slide in the same direction, and preferably along exactly the same axis of sliding (represented by the axis X-X′), as shown in the figures. Preferably, the machine 1 includes actuation means 14 (visible in FIG. 2) for actuating the pre-compression carriage 13, which means are designed to cause the pre-compression carriage 13 to move, i.e. preferably to cause said pre-compression carriage 13 to slide in the direction represented by the axis X-X′. Preferably, the actuation means 14 comprise an actuator 15 that actuates the pre-compression carriage 13 so as to move it between a high abutment position (shown in FIGS. 1 to 3) and a low abutment position (shown in FIGS. 5 to 7).

Advantageously, the pre-compression carriage 13 is designed so that, when it moves, it comes to move the reception and centering carriage 11 via the annular part 2 that is resting thereon.

Preferably, the pre-compression carriage 13 is positioned above the reception and centering carriage 11 in a manner such that the annular part 2 is interposed between the reception and centering carriage 11 (and more particularly the tubes 8A) and the pre-compression carriage 13 (and more precisely the section-reducing plates 5, 6). Thus when the pre-compression carriage 13 moves down vertically under the effect of the action of the actuator 15, the section-reducing plates (5, 6) come into abutment against the annular part 2 and exert downward vertical thrust thereon, which downward vertical thrust is transmitted via the tubes 8A to the reception and centering carriage 11. Under the effect of this downward thrust, said reception and centering carriage leaves its return high abutment position and moves down, against the action of the springs 110, until it reaches its low abutment position. This sequence in which the reception and centering carriage 11 moves downwards is shown in FIGS. 3 and 4. While the reception and centering carriage 11 is moving downwards, the annular part 2 concomitantly undergoes progressive deformation, as described in more detail below.

The use of such a system having two slidably mounted carriages makes it possible, in particular, to generate pre-folding of the annular part 2 (as shown in FIG. 4) that facilitates the subsequent folding proper operation.

Advantageously, the machine 1 of the invention further includes a pusher member 16, said section-reducing passage 4 and said pusher member 16 being mounted to move relative to each other so as to force the annular part 2 through the section-reducing passage 4.

Thus, in the embodiment shown in the figures, the pusher member 16 and the pre-compression carriage 13 are mounted to move relative to each other in such a manner as to exert on the annular part 2 a force tending to force said part through the gap between the section-reducing plates 5, 6 forming the section-reducing passage 4.

Advantageously, the machine 1 is designed to perform the following sequence of operations:
The actuation means 14 for actuating the pre-compression carriage 13 cause the pre-compression carriage 13 to slide in the direction X-X′ (downwards). The pre-compression carriage 13 in turn pushes the reception and centering carriage 11 via the annular part 2 resting on said reception and centering carriage 11, until said reception and centering carriage is brought to and held in an abutment position, corresponding in this example to the low abutment position. The reception and centering carriage 11 moving towards said (low) abutment position presses the annular part 2 against the pusher member 16, thereby generating pre-folding (or pre-compression) of the annular part 2 as shown in FIG. 4.
While the reception and centering carriage 11 is held in its (low) abutment position by the pre-compression carriage 13 and by the actuation means 14 thereof, the pusher member 16 then exerts thrust (preferably upward vertical thrust) on the pre-folded annular part 2 so as to force said annular part through the section-reducing passage 4.

Thus, as shown in the figures, the machine 1 makes it possible to treat the annular part 2 in two main steps:
A pre-compression step in which the pusher member 16 acts as a passive support against which the annular part 2 is flattened by the section-reducing plates 5, 6 moving downwards. Under the effect of this downward movement, the section-reducing plates 5, 6 come to be pressed against the edge face of the annular part 2 (i.e. the tread strip 3 when the annular part 2 is constituted by a tire) and pivot in such a manner as to take up an upside-down V-shaped profile, as shown in FIGS. 3 and 4. The pre-compression carriage 13, actuated by the actuator 15, thus comes to flatten the annular part 2 against the pusher member 16.
Once the downward stroke of the pre-compression carriage 13 is complete, a folding proper step starts (shown in FIGS. 5 to 7) in which the pusher member 16 plays an active part and exerts upward vertical thrust that forces the pre-folded annular part 2 through the gap between the section-reducing plates 5, 6, thereby causing them to pivot so that they close onto the annular part 2 so as to compress it and fold it. The section-reducing plates 5, 6 thus go from an upside-down V-shaped configuration to a configuration in which they are parallel to each other, as shown in FIGS. 5 to 7.

Advantageously, the pusher member 16 exerts a thrust force that is substantially local, at a point, directed radially, and preferably in the vertical direction represented by the axis X-X′. Advantageously, the pusher member 16 comprises a pusher rod 16A actuated by an actuator 168. Preferably, the pusher rod 16A is constituted directly by the pusher actuator 168, said rod 16A being guided by a centering side plate 17 fastened to the tip of the actuator 168 and having a guide ring.

Such a construction is extremely compact, simple, cheap, and inexpensive.

Preferably, and as explained in more detail below, the pusher rod 16A also acts as a rod for removing the part 2.

Under the effect of the radial thrust exerted by the pusher rod 16A, the annular part 2 is propelled into and along the section-reducing passage 4, thereby causing the section-reducing plates 5, 6 to pivot about their respective axes 5A, 6A, said section-reducing plates 5, 6 then forming a clamp that reduces the section of the annular part 2, as shown in FIG. 5.

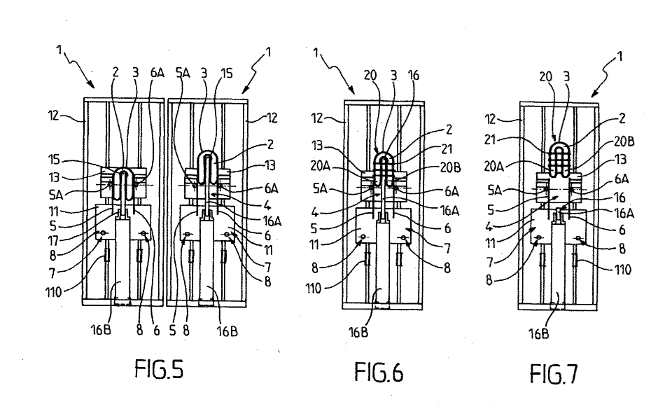

Advantageously, the machine 1 is designed so as also to bind the compressed annular part 2 as it leaves the section-reducing passage 4. Preferably, and as shown in FIG. 6, binding the compressed annular part 2 (i.e. the annular part 2 as folded) starts before the annular part 2 has fully exited from the section-reducing passage 4, in order to avoid untimely unfolding of the annular part 2 by elastic return. The binding advantageously consists in placing one or more ties (e.g. at least two ties) around the folded annular part 2 (about the axis X-X′) by using any known method. The machine is designed such that, once the binding has been performed, the pusher member 16 extracts the part 2 from the grip of the section-reducing passage 4, it then being possible for the folded and bound part 2 to be recovered and to continue on its treatment cycle while having a significantly reduced overall volume.

The invention also relates as such to a method of compacting an annular part 2 made of a flexible material that advantageously constitutes a method of compacting tires for reducing the storage volume and the transport volume of said tires. The method of the invention is advantageously designed to be implemented using the machine 1 of the invention. The method of the invention is a method in which the annular part 2 is forced through a section-reducing passage 4 in order to be folded. The section-reducing passage 4 is defined by at least one pivotally mounted section-reducing plate 5, said section-reducing plate 5 pivoting, under thrust from the annular part 2, so as to come to close onto the annular part 2 in order to compress it. As shown in the figures, and as explained in more detail above, the section-reducing passage 4 is advantageously defined by two section-reducing plates 5, 6, each of which is pivotally mounted so that, under thrust from the annular part 2, the section-reducing plates 5, 6 pivot so as to close onto the annular part 2 in order to compress it.

Advantageously, the method of the invention includes a reception and centering step for receiving and centering the annular part 2, as shown in FIG. 3. This reception and centering step corresponds to an operation for loading the compactor machine 1 with an annular part 2 made of a flexible material for compacting. Advantageously, during said reception and centering step for receiving and centering the annular part 2, said annular part is deposited on a slidably mounted reception and centering carriage 11, as explained above and as shown in FIG. 3. Preferably, the section-reducing plate(s) 5, 6 are pivotally mounted on a slidably mounted pre-compression carriage 13, as explained above.

The method also advantageously includes a pre-compression step (shown in FIG. 4) in which the pre-compression carriage 13 slides so as to push the reception and centering carriage 11 via the annular part 2 resting thereon, until the reception and centering carriage 11 is brought into and held in an abutment position (corresponding to the above-mentioned low position). The reception and centering carriage 11 moving towards said abutment position pressing the annular part 2 against a pusher member 16, thereby generating pre-folding of the annular part 2.

During the pre-compression, the reaction thrust exerted by the annular part 2 on the section-reducing plates 5, 6 causes said section-reducing plates to pivot symmetrically about their respective axes 5A, 6A, so that, at the end of the pre-compression step, said section-reducing plates 5, 6 form an upside-down V-shape, as shown in FIG. 4. The pusher member 16 preferably exerts an upward vertical reaction force that is substantially localized.

In this way, the pre-folded annular part 2 has a bi-lobe shape, i.e. it forms two lobes (in the form of loops) interconnected via a section constriction corresponding to the place where the pusher member 16 acts on the annular part 2.

Advantageously, and as shown in FIG. 5, the method of the invention includes a folding step (also referred to as a “section-reducing step”) during which, while the reception and centering plate 11 is held in its abutment position, the pusher member 16 exerts thrust (preferably upward vertical thrust) on the pre-folded annular part 2 (obtained at the end of the pre-compression step), so as to force said annular part through the section-reducing passage 4. Thus, in the folding step shown in FIG. 5, the pre-compression carriage 13 is held stationary and the pre-folded part 2 is pushed between the section-reducing plates 5, 6 by the pusher member 16. This causes the section-reducing plates 5, 6 to pivot towards each other, until said section-reducing plates 5, 6 come naturally into a mutually parallel position, thereby forming a clamp for reducing the section of the part 2 that is propelled between them. During the folding step, the pusher member 16 advantageously exerts radial and preferably localized thrust on the annular part 2.

Finally, the method advantageously includes a step of binding the compressed annular part 2 exiting from the section-reducing passage 4, as explained above.

The invention also relates as such to a system 20 that can be obtained by the method of the invention.

This system 20 comprises a tire (preferably a used tire) that is folded in such manner as to form two lobes 20A, 208 that are interconnected by a section constriction resulting from local centripetal compression of the tire, said lobes 20A, 208 being folded over one against the other, as shown in FIGS. 6 and 7. In accordance with the invention, the tire folded in this way is substantially whole, i.e. it has not had any material taken from it by operations of the cutting or shearing type. In other words, the system 20 of the invention comprises a raw tire, substantially exempt from any cutting or punching.

Advantageously, the system 20 of the invention further comprises means 21 for holding the tire as folded in this way. The means 21 for holding the tire folded preferably comprise at least one tie 21A surrounding the folded tire, and, for example, three ties as in the example shown in the figures.

### SUSCEPTIBILITY OF INDUSTRIAL APPLICATION

The invention is susceptible of industrial application in compacting flexible parts.

1. A machine (1) for compacting an annular part (2) made of a flexible material, said machine (1) having a section-reducing passage (4) through which the annular part (2) is forced in order to be folded, said machine (1) being characterized in that said section-reducing passage (4) is defined by at least one section-reducing plate (5) that is pivotally mounted so that, under thrust from said annular part (2), said section-reducing plate (5) pivots so as to come to close onto said annular part (2) in order to compress it.

2. A machine (1) according to claim 1, characterized in that the section-reducing passage (4) is defined by two section-reducing plates (5, 6), each of which is pivotally mounted so that, under thrust from said annular part (2), said section-reducing plates pivot so as to come to close onto said annular part (2) in order to compress it.

3. A machine according to claim 1, characterized in that it has reception and centering means for receiving and centering the annular part.

4. (canceled)

5. (canceled)

6. (canceled)

7. A machine (1) according to claim 3, characterized in that the reception and centering means (7) include lateral centering means (9) provided with at least one moving clamping plate (9A, 9B).

8. A machine (1) according to claim 3, characterized in that said reception and centering means (7) comprise a slidably mounted reception and centering carriage (11).

9. A machine (1) according to claim 1, characterized in that it includes a slidably mounted pre-compression carriage (13) on which said section-reducing plate(s) (5, 6) are pivotally mounted.

10. A machine according to claim 8, characterized in that said pre-compression carriage is designed to slide in the same direction as the reception and centering carriage.

11. A machine (1) according to claim 10, characterized in that it includes actuation means (14) for actuating the pre-compression carriage (13), which actuation means are designed to cause said pre-compression carriage (13) to slide, which carriage is designed so that, when it moves, it comes to move the reception and centering carriage (11) via the annular part (2) resting thereon.

12. A machine (1) according to claim 1, characterized in that it includes a pusher member (16), said section-reducing passage (4) and said pusher member (15) being mounted to move relative to each other so as to force the annular part (2) through the section-reducing passage (4).

13. A machine (1) according to claim 12, characterized in that it is designed to perform the following sequence of operations:
a) the actuation means (14) for actuating the pre-compression carriage (13) cause the pre-compression carriage to slide, which carriage in turn pushes the reception and centering carriage (11) via the annular part (2) resting thereon, until the reception and centering carriage (11) is brought into and held in an abutment position, the reception and centering carriage (11) moving towards said abutment position pressing the annular part (2) against the pusher member (16), thereby generating pre-folding of the annular part (2);
b) while the reception and centering carriage (11) is held in its abutment position, the pusher member (16) exerts thrust on the pre-folded annular part (2) so as to force it through the section-reducing passage (4).

14. A machine (1) according to claim 13, characterized in that the pusher member (16) comprises a pusher rod (16A) actuated by an actuator (16B).

15. A machine (1) according to claim 14, characterized in that said pusher member (16) is designed to exert radial thrust on the annular part (2).

16. A machine (1) according to claim 1, characterized in that it is designed to bind the compressed annular part (2) exiting from the section-reducing passage (4).

17. A machine (1) according to claim 1, characterized in that it constitutes a machine for compacting tires for reducing the storage volume and the transport volume thereof.

18. A method of compacting an annular part (2) made of a flexible material, in which method the annular part (2) is forced through a section-reducing passage (4) in order to be folded, said method being characterized in that said section-reducing passage is defined by at least one section-reducing plate (5) that is pivotally mounted so that, under thrust from said annular part (2), said section-reducing plate (5) pivots so as to come to close onto said annular part (2) in order to compress it.

19. A method according to claim 18, characterized in that the section-reducing passage is defined by two section-reducing plates (5, 6) each of which is pivotally mounted so that, under thrust from said annular part, said section-reducing plates (5, 6) pivot so as to come to close onto said annular part (2) in order to compress it.

20. (canceled)

21. (canceled)

22. (canceled)

23. (canceled)

24. (canceled)

25. (canceled)

26. A method according to claim 18, characterized in that it constitutes a method of compacting tires so as to reduce the storage volume and the transport volume thereof.

27. A system (20) comprising a pneumatic tire that is folded in such a manner as to form two lobes (20A, 20B) interconnected by a section constriction resulting from the tire being subjected to local centripetal compression, said lobes (20A, 20B) being folded over one against the other, said system being characterized in that said tire is substantially whole.

28. A system (20) according to claim 27, characterized in that it further comprises means (21) for holding the tire as folded in this way.

29. A system (20) according to claim 28, characterized in that said means (21) for holding the tire as folded comprise at least one tie surrounding the tire as folded.
